(19) United States
(12) Patent Application Publication
(10) Pub. No.: US 2024/0312272 A1
(43) Pub. Date: Sep. 19, 2024

(54) Method for Verifying an Identity of an Electronic Device and Related Device

(71) Applicant: Huawei Technologies Co., Ltd., Shenzhen (CN)

(72) Inventors: Girish Shivalingappa Revadigar, Singapore (SG); Zhuo Wei, Singapore (SG); Qinyong Jia, Shanghai (CN)

(21) Appl. No.: 18/677,215

(22) Filed: May 29, 2024

Related U.S. Application Data
(63) Continuation of application No. PCT/CN2021/134565, filed on Nov. 30, 2021.

(51) Int. Cl. G07C 9/00; G06F 21/64

(52) U.S. Cl. CPC G07C 9/00309; G06F 21/64; G07C 2009/00388

(57) ABSTRACT

A method for verifying an identity of an electronic device includes: transmitting, by a first electronic device, N challenge packet(s) to a second electronic device; receiving, by the first electronic device, N response packet(s) from the second electronic device, where the N response packet(s) are in one-to-one correspondence with the N challenge packet(s); determining, by the first electronic device, a first verification information, according to the N response packet(s), where the first verification information indicates received signal strength (RSS) information of the N response packet(s); obtaining, by the first electronic device, a second verification information from the second electronic device, where the second verification information indicates RSS information of the N challenge packet(s); and verifying, according to the first verification information and the second verification information, an identity of the second electronic device.

### CROSS-REFERENCE TO RELATED APPLICATIONS

This is a continuation of International Patent Application No. PCT/CN2021/134565 filed on Nov. 30, 2021, which is hereby incorporated by reference in its entirety.

### TECHNICAL FIELD

Embodiments of the present disclosure relate to the field of information technologies, and in particular, to a method for verifying an identity of an electronic device and a related device.

### BACKGROUND

Keyless entry systems (KES) for vehicles/automobiles are becoming more and more popular for their ease of usage. With the KES, a physical key of a car need not be carried by every user, and multiple users can be authorized by the car's owner to use his/her car. The KES use a digital key stored in user's personal device e.g., mobile phone, which is provided to the user by a trusted entity at the time of user registration. BLUETOOTH Low Energy (BLE) technology is used to communicate between the car and user's device. FIG. 1 illustrates the example of such architecture. As shown in FIG. 1, the owner's personal device stores the digital key of the car. The car sends commands/messages for finding the key in its range. When the owner's personal device listens to the commands/messages sent by car, it responds to the commands/messages. The car receives the commands sent by the owner's personal device, interprets them as commands sent by the owner's personal device, and then unlocks the car. The owner may authorize the user's device 1 to use his/her car. The authorized user's device 1 responses the commands sent by the car. The car receives the commands sent by the authorized user's device 1, interprets them as commands sent by the authorized device, and then unlocks the car.

The current solutions for KES are vulnerable for relay attack and other active attack which is serious issue. Some of the existing solutions use distance estimation methods to calculate the distance between the mobile device and the car using signal features. If the device is found to be in the range, then the car accepts the commands.

### SUMMARY

Embodiments of this disclosure provide a method for verifying an identity of an electronic device and a related device. The technical solution may provide an efficiently identity authentication procedure by using the property of the received signal strength (RSS).

According to a first aspect, an embodiment of this disclosure provides a method for verifying an identity of an electronic device, including transmitting, by a first electronic device, N challenge packet(s) to a second electronic device, wherein N being a positive integer greater than or equal to 1, receiving, by the first electronic device, N response packet(s) from the second electronic device, wherein the N response packet(s) being in one-to-one correspondence with the N challenge packet(s), determining, by the first electronic device, a first verification information, according to the N response packet(s), wherein the first verification information being used to indicate RSS information of the N response packet(s), obtaining, by the first electronic device, a second verification information from the second electronic device, wherein the second verification information being used to indicate RSS information of the N challenge packet(s), verifying, according to the first verification information and the second verification information, an identity of the second electronic device.

The above-mentioned technical solution provides an efficiently identity authentication procedure by using the property of the RSS. Only the pair of connected wireless devices can have similar RSS values due to reciprocity property of wireless channel. If another device (e.g., an adversary) is present in the same vicinity, and is able to overhear all the communication in the same channel used by legitimate devices, the RSS observed by the adversary (by received packet(s)/signal) will be un-correlated with regard to the legitimate devices due to multi-path effects of wireless channel. Therefore, the technical solution may secure authenticated ranging and

In a possible design, wherein before transmitting, by a first electronic device, N challenge packet(s) to a second electronic device, the method further includes determining, by the first electronic device, a number use once (nonce), transmitting, by the first electronic device, the nonce to the second electronic device, determining, by the first electronic device, the N challenge packet(s), wherein each of the N challenge packet(s) includes a first encryption information encrypted by a preset key, wherein the first encryption information includes the nonce.

In a possible design, wherein transmitting, by the first electronic device, the nonce to the second electronic device, includes encrypting, by the first electronic device, the nonce using the preset key, transmitting, by the first electronic device, encrypted nonce to the second electronic device.

In a possible design, wherein the first encryption information may further include a packet index and a first command identification (ID).

The nonce is used during the identity authentication procedure. Therefore, the security may be further improved.

In a possible design, wherein each of the N challenge packet(s) includes a first check information which being used to verify data integrity of the first encryption information in each of the N challenge packet(s).

According to the first check information, the data integrity of the first encryption information in each of the N challenge packet(s) may be verified.

In a possible design, wherein determining, by the first electronic device, a first verification information, according to the N response packet(s), includes determining, by the first electronic device, K piece(s) of RSS information according to the N response packet(s), wherein each of the K piece(s) of the RSS information being in correspondence with one of the N response packet(s), K being a positive integer greater than or equal to N, determining, by the first electronic device, the first verification information according to the K piece(s) of the RSS information.

In a possible design, wherein before determining, by the first electronic device, K piece(s) of RSS information according to the N response packet(s), the method further includes determining the N response packet(s) are trusted according to the nonce in each of the N response packet(s).

For example, each of the N response packet(s) may include a second encryption information and a second check information. The second encryption information may include the nonce. The key used to encrypt/decrypt the second encryption information may be the same as the key used to encrypt/decrypt the first encryption information. The first electronic device may use the key to decrypt the second information to obtain decrypted information (that is the nonce). The first electronic device may compare the nonce in the decrypted information with the previously received nonce. If the nonce in the decrypted information and the previously transmitted nonce are the same, the first electronic device may use the second check information to verify data integrity of the encrypted information. If the encrypted information passes the verification, the first electronic device may determine that the response packet is a trusted packet, if the encrypted information does not pass the verification, the first electronic device may indicate the second electronic device to retransmit the response packet. If the nonce in the decrypted information and the previously transmitted nonce are different, the first electronic device may determine that the response packet is not a trusted packet.

In a possible design, wherein determining, by the first electronic device, the first verification information according to the K piece(s) of the RSS information, includes applying, by the first electronic device, a filter to the K piece(s) of the RSS information to obtain M piece(s) of the RSS information, wherein M being a positive integer less than or equal to K, determining, by the first electronic device, the first verification information according to the M piece(s) of the RSS information.

According to the above-mentioned technical solution, the filter may be used to remove noise component and make the signal smooth.

In a possible design, wherein determining, by the first electronic device, the first verification information according to the M piece(s) of the RSS information, includes determining, by the first electronic device, M piece(s) of RSS level information according to the M pieces of the RSS information, wherein the M piece(s) of the RSS level information being in one-to-one correspondence with the M piece(s) of the RSS information, determining, by the first electronic device, the first verification information according to the M piece(s) of the RSS level information.

In a possible design, wherein the verifying, according to the first verification information and the second verification information, an identity of the second electronic device, includes determining, by the first electronic device, similarity of the first verification information and the second verification information, if the similarity of the first verification information and the second verification information is more than a threshold, transmitting a successful authentication indication to the second electronic device, wherein the successful authentication indication being used to indicate that the second electronic device passed identity authentication.

According to a second aspect, an embodiment of this disclosure provides a method for verifying an identity of an electronic device, including receiving, by a second electronic device, N challenge packet(s) from a first electronic device, wherein N being a positive integer greater than or equal to 1, transmitting, by the second electronic device, N response packet(s) to the first electronic device, wherein the N response packet(s) being in one-to-one correspondence with the N challenge packet(s), determining, by the second electronic device, a second verification information according to the N challenge packet(s), wherein the second verification information being used to indicate RSS information of the N challenge packet(s), transmitting, by the second electronic device, the second verification information to the first electronic device.

The above-mentioned technical solution provides an efficiently identity authentication procedure by using the property of the RSS. Only the pair of connected wireless devices can have similar RSS values due to reciprocity property of wireless channel. If another device (e.g., an adversary) is present in the same vicinity, and is able to overhear all the communication in the same channel used by legitimate devices, the RSS observed by the adversary (by received packets/signal) will be un-correlated with regard to the legitimate devices due to multi-path effects of wireless channel. Therefore, the technical solution may secure authenticated ranging and

In a possible design, wherein before, receiving, by a second electronic device, N challenge packet(s) from a first electronic device, the method further includes receiving, by the second electronic device, a number use once (nonce) from the first electronic device, before transmitting, by the second electronic device, N response packet(s) to the first electronic device, the method further includes determining, by the second electronic device, the N response packet(s), wherein each of the N response packet(s) includes a second encryption information encrypted by a preset key, wherein the second encryption information includes the nonce.

In a possible design, wherein receiving, by the second electronic device, a number use once (nonce) from the first electronic device, includes receiving, by the second electronic device, encrypted nonce from the first electronic device, decrypting, by the second electronic device, the encrypted nonce using the preset key to obtain the nonce.

In a possible design, wherein the second encryption information may further include a packet index and a second command ID.

The nonce is used during the identity authentication procedure. Therefore, the security may be further improved.

In a possible design, wherein each of the N response packet(s) includes a second check information which being used to verify data integrity of the second encryption information in each of the N response packet(s).

According to the first check information, the data integrity of the first encryption information in each of the N challenge packet(s) may be verified.

In a possible design, wherein determining, by the second electronic device, a second verification information according to the N challenge packet(s), includes determining, by the second electronic device, K piece(s) of RSS information according to the N challenge packet(s), wherein each of the K piece(s) of the RSS information being in correspondence with one of the N response packet(s), K being a positive integer greater than or equal to N, determining, by the second electronic device, the second verification information according to the K piece(s) of the RSS information.

In a possible design, wherein before determining, by the second electronic device, K piece(s) of RSS information according to the N challenge packet(s), the method further includes determining the N challenge packet(s) are trusted according to the nonce in each of the N challenge packet(s).

The second electronic device may receive the nonce from the first device before receiving the N challenge packet(s). Under this condition, the challenge packet transmitted by the first electronic device may carry the nonce. The second electronic device may determine whether the nonce carried in challenge packet is the same as the nonce received before. If it is yes, the second electronic device may determine that the received challenge packet is trusted, if not, the first electronic device may determine that the received challenge packet is untrusted.

In a possible design, wherein determining, by the second electronic device, the second verification information according to the K piece(s) of the RSS information, includes applying, by the second electronic device, a filter to the K piece(s) of the RSS information to obtain M piece(s) of the RSS information, wherein M being a positive integer less than or equal to K, determining, by the second electronic device, the second verification information according to the M piece(s) of the RSS information.

According to the above-mentioned technical solution, the filter may be used to remove noise component and make the signal smooth.

In a possible design, wherein determining, by the second electronic device, the second verification information according to the M piece(s) of the RSS information, includes determining, by the second electronic device, M piece(s) of RSS level information according to the M piece(s) of the RSS information, wherein the M piece(s) of the RSS level information being in one-to-one correspondence with the M piece(s) of the RSS information, determining, by the second electronic device, the second verification information according to the M piece(s) of the RSS level information.

According to a third aspect, an embodiment of this disclosure provides an electronic device, and the electronic device has function of implementing the method in the first aspect. The function may be implemented by hardware, or may be implemented by hardware executing corresponding software. The hardware of the software includes one or more modules corresponding to the function.

According to a fourth aspect, an embodiment of this disclosure provides an electronic device, and the electronic device has function of implementing the method in the second aspect. The function may be implemented by hardware, or may be implemented by hardware executing corresponding software. The hardware of the software includes one or more modules corresponding to the function.

According to a fifth aspect, an embodiment of this disclosure provides a computer readable storage medium, including instructions. When the instructions runs on a computer, the computer is enabled to perform the method in the first aspect or any possible implementation of the first aspect.

According to a sixth aspect, an embodiment of this disclosure provides a computer readable storage medium, including instructions. When the instructions runs on a computer, the computer is enabled to perform the method in the second aspect or any possible implementation of the second aspect.

According to a seventh aspect, an electronic device is provided, including a processor and a memory. The processor is connected to the memory. The memory is configured to store instructions, the processor is configured to execute the instructions. When the processor executes the instructions stored in the memory, the processor is enabled to perform the method in the first aspect or any possible implementation of the first aspect.

According to an eighth aspect, an electronic device is provided, including a processor and a memory. The processor is connected to the memory. The memory is configured to store instructions, the processor is configured to execute the instructions. When the processor executes the instructions stored in the memory, the processor is enabled to perform the method in the second aspect or any possible implementation of the second aspect.

According to a ninth aspect, a chip system is provided, where the chip systems includes a memory and a processor, wherein the memory is configured to store a computer program, and the processor is configured to invoke the computer program from the memory and run the computer program, so that a server on which the chip is disposed performs the method in the first aspect or any possible implementation of the first aspect.

According to a tenth aspect, a chip system is provided, where the chip systems includes a memory and a processor, wherein the memory is configured to store a computer program, and the processor is configured to invoke the computer program from the memory and run the computer program, so that a server on which the chip is disposed performs the method in the second aspect or any possible implementation of the second aspect.

According to a eleventh aspect, a computer program product is provided, wherein when the computer program product runs on an electronic device, the electronic device is enabled to perform the method in the first aspect or any possible implementation of the first aspect.

According to a twelfth aspect, a computer program product is provided, wherein when the computer program product runs on an electronic device, the electronic device is enabled to perform the method in the second aspect or any possible implementation of the second aspect.

According to a thirteenth aspect, a vehicle is provided, wherein the vehicle incudes the electronic device in the third aspect.

### DESCRIPTION OF DRAWINGS

FIG. 1 shows a keyless entry system.

FIG. 2 shows a relay attack scenario.

FIG. 3 shows a flowchart of the embodiment of a method for verifying an identity of an electronic device.

FIG. 4 shows a flowchart of the embodiment of a method for verifying an identity of an electronic device.

FIG. 5 is a schematic block diagram of an electronic device according to an embodiment of this disclosure.

FIG. 6 is a schematic block diagram of an electronic device according to an embodiment of this disclosure.

FIG. 7 is a schematic block diagram of an electronic device according to an embodiment of this disclosure.

FIG. 8 is a schematic block diagram of an electronic device according to an embodiment of this disclosure.

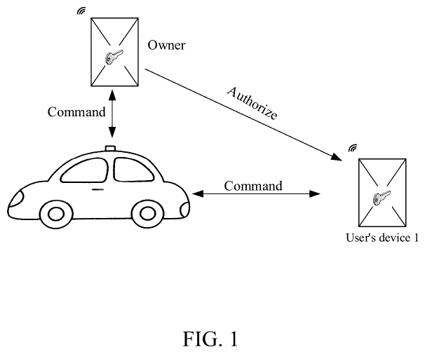

### DESCRIPTION OF EMBODIMENTS

The following describes the technical solutions in this disclosure with reference to the accompanying drawings.

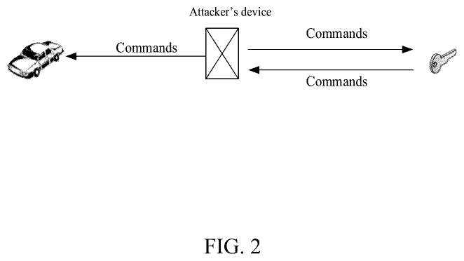

FIG. 2 shows a relay attack scenario.

An attacker's device communicates with a real key/user's device impersonating as a car. In another word, the attacker's device sends commands/messages sent by the car for finding the key in its range. When the real key/user's device listens to the commands/messages sent by attacker's device, it responds to the commands/messages assuming it is the user's legitimate/own car. The attacker's device then captures/records the signal from the real key/user's device, amplifies and transmits to car. The car receives the messages sent by the attacker's device, and interprets them as commands sent by the real key/user's device. Thus, the attacker can easily unlock and steal the car. Similarly, the attacker can also record and reply the messages between the car and the real key/user's device to unlock and steal the car. These are some of the most serious threats to KES, and thus, the security of KES solutions is very important to prevent such attacks.

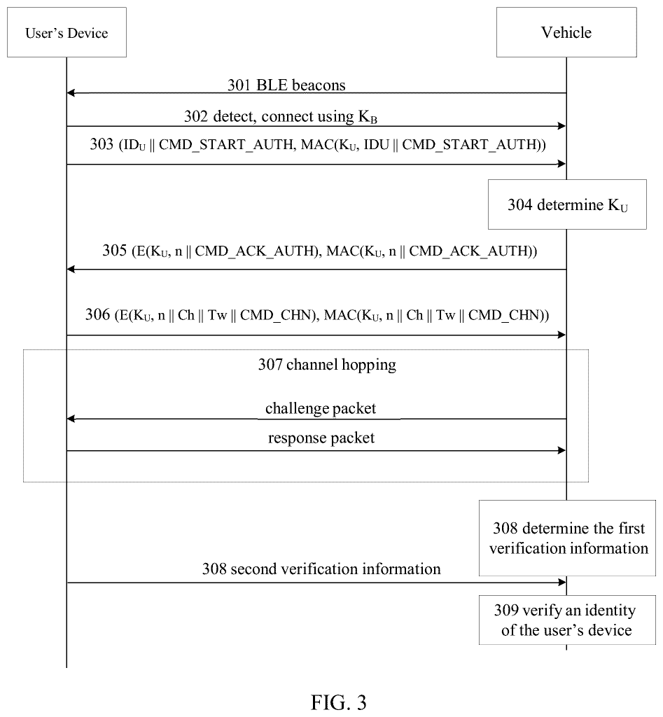

FIG. 3 shows a flowchart of the embodiment of a method for verifying an identity of an electronic device.
Step 301: A vehicle transmits periodic BLE beacons.

In some embodiments of the present application, the vehicle may include one or more antenna arrays. The antenna arrays may be thin and flexible antenna, which can be attached to any flat surface of vehicle. Each array can be connected to same BLE Module or different BLE module of the vehicle. The vehicle can decide which BLE module to use based on current user approaching direction.
Step 302: A user's device detects the BLE beacons and connects to the vehicle via BLE using a BLUETOOTH connection key (KB).

The user's device may be a real key of the vehicle, a mobile phone which stores a digital key of the vehicle, or the like. The KB is shared between the user's device and the vehicle by a trusted entity e.g., cloud service, which is used for BLUETOOTH connection establishment and for encrypting the BLE communication.
Step 303: The user's device transmits an ID of the user's device (ID_{U}) and a command ID to the vehicle. The command ID may be used to indicate a start of authentication.

ID_{U} is assigned by the trusted party e.g., cloud service. ID_{U} is unique per user device, non-transferrable, and bound to the user's device.

Optionally, the user's device may further transmit a check information to the vehicle. The check information is used to verify data integrity of information sent by the user's device (that is, the ID of the user's device, and the command ID). According to the check information, the vehicle may determine that whether the information sent by the user's device has been tampered with. The check information may be message authentication code (MAC) of the information sent by the user's device, hash-based MAC (HMAC) of the information sent by the user's device, or the like.

For example, the user's device may send the following message to the vehicle: (ID_{U} ∥ CMD_START_AUTH, MAC(K_{U}, ID_{U} ∥ CMD_START_AUTH)), wherein ID_{U} is the ID of the user's device, CMD_START_AUTH is the command ID for indicating the start of the authentication. MAC(k, m) denotes message authentication code of m using key k. K_{U} is shared between the user's device and the vehicle by a trusted entity e.g., cloud server, which is unique and bound to the device, non-transferable. The Ku may be used for encrypting the command/data in BLE packets for enhanced security.

For another example, the user' device may send two messages to the vehicle, wherein the first message is used to carry ID_{U} and CMD_START_AUTH, and the second message is used to carry MAC(K_{U}, ID_{U} ∥ CMD_START_AUTH).

Corresponding, the vehicle receives the information sent by the user's device in step 303. If the vehicle receives the check information from the user's device, the vehicle may use the check information to verify the data integrity of the ID_{U} and CMD_START_AUTH. If the ID_{U} and CMD_START_AUTH pass the data integrity verification, the vehicle may perform the following steps.
Step 304: The vehicle determines a key according to the ID of the user's device.

In some embodiments of the present application, the key determined according to the ID of the user's device may be the same as the key which is used to determine the MAC of the information sent by the user's device in step 303, that is Ku. Under this condition, the vehicle may determines the Ku according to the ID of the user's device, and then determine whether the received information passes data integrity the authentication.

In some another embodiments of the present application, the key determined according to the ID of the user's device may be different from the key which is used to determine the MAC of the information sent by the user's device in step 303.
Step 305: The vehicle determines a number use once (nonce), and transmits the nonce to the user's device.

Optionally, the nonce is an arbitrary number generated by the vehicle.

Optionally, the vehicle may also transmits a command ID with the nonce to the user's device, wherein the command ID is used to indicate that the vehicle has successfully received ID_{U} and CMD_START_AUTH sent by the user's device.

The nonce and the command ID may be encrypted using the key determined in step 304.

Similarly, the vehicle may further send a check information to the user's device. The check information is used to verify data integrity of the information sent by the vehicle (that is, the nonce and the command ID).

For example, the vehicle may send the following message to the user's device: (E(K_{U}, n ∥ CMD_ACK_AUTH), MAC(K_{U}, n ∥ CMD_ACK_AUTH)), wherein E(k, m) denotes encryption of message m using key k, n is the nonce, CMD_ACK_AUTH is the command ID which is used to indicate that the vehicle has successfully received the nonce and the CMD_START_AUTH sent by the user's device.

Similarly, the vehicle may also send two message to the user's device, wherein one of the two messages carries the encrypted information (that is, the nonce and CMD_ACK_AUTH), and another messages carries the check information.

Corresponding, the user's device may receive the information sent by the vehicle in step 306. The user's device may use the key to decrypt the received message to obtain the nonce and the CMD_START_AUTH. Further, the user's device may further use the received check information to determine whether the nonce and the CMD_START_AUTH pass the data integrity verification. If the nonce and the CMD_START_AUTH pass the data integrity verification, the user's device may perform the following steps.

Step 306: The user's device determines a random channel sequence and a wait period and transmits the channel sequence and the wait period to the vehicle.

The user's device may transmit the nonce received in step 305 to the vehicle along with the channel sequence and the wait period.

Similarly, the user's device may transmit a command ID to the vehicle.

Similarly, the user's device may first encrypt the information to be sent (e.g. the channel sequence, the wait period, the nonce, the command ID), and then send the encrypted information to the vehicle.

For example, the user's device may send the following message to the vehicle: (E(K_{U}, n ∥ Ch ∥ Tw ∥ CMD_CHN), MAC(K_{U}, n ∥ Ch ∥ Tw ∥ CMD_CHN)), wherein Ch is the channel sequence, Tw is the wait period, and CMD_CHN is the command ID. The waiting period is the amount of time to stay on the antenna after the switch completes transmitting/receiving of the data packet and collecting the RSS indicator (RSSI).

Correspondingly, the vehicle receives the information sent by the user's device in step 306. The vehicle may use the key to decrypt the received information to obtain the nonce, the Ch, the Tw and the CMD_CHN. Further, the user's device may further use the received check information to determine whether the nonce, the Ch, the Tw and the CMD_CHN pass the data integrity verification. If the nonce, the Ch, the Tw and the CMD_CHN pass the data integrity verification, the user's device may perform the following steps.
Step 307: The vehicle and the user's device start channel hopping according to the Tw and the Ch.

For the vehicle, the vehicle may generate a random antenna switch sequence (hereinafter referred as “A_{S}”), extract the received channel sequence (that is the Ch), and start channel hopping along with antenna switch. On each channel, the vehicle may transmit a challenge packet, receive a response packet and record RSSI of the received response packet. After time gap of T_{Gi}, the vehicle switches its antenna to another as per A_{S}. T_{Gi} is a preset value, usually a few hundred milliseconds. In some embodiments, T_{Gi}=Tw. Repeat this till N number of RSSI are collected, N is a positive integer greater than or equal to 1. Corresponding, the user's device may receive the challenge packet, transmit a response packet and record RSSI of the received challenge packet.

The challenge packet may include the following content: (E(Ku, n ∥ i ∥ CMD_CH), MAC(n ∥ i ∥ CMD_CH)) where i is the packet index, and CMD_CH is command ID for indicating the channel that transmitted the challenge packet. CMD_CH is an example of a first command ID.

The response packet may include the following content: (E(Ku, n ∥ i ∥ CMD_RSP), MAC(n ∥ i ∥ CMD_RSP)) where i is the packet index, and CMD_RSP is command ID for indicating the response packet. CMD_RSP is an example of the second command ID.

In some embodiments, the RSSI may be in one-to-one correspondence with the response packet. In other word, the vehicle may determine one RSSI according to one response packet. Similarly, the RSSI may be in one-to-one correspondence with the challenge packet, that is, the user's device may determine one RSSI according to one challenge packet.

In some another embodiments, two or more RSSIs may correspond to one response packets. In other word, the vehicle may determine more than one RSSI according to one response packet. Similarly, the user's device may determine more than one RSSI according to one challenge packet.

In the above-mentioned embodiments, all of the information transmitted between the user's device and the vehicle after the step 304 (e.g., the nonce, the packet index, the channel sequence, the wait period and so on) is encrypted. In some another embodiments, only part of the information transmitted between the user's device and the vehicle may be encrypted. For example, the nonce may be encrypted, and other information (e.g. the packet index, the command ID and so on) does not need to be encrypted. For another example, the nonce, the channel sequence and the wait period may be encrypted, and other information (e.g. the packet index, the command ID and so on) does not need to be encrypted.
Step 308: The vehicle determines a first verification information according to the recorded RSSIs. The user's device determines a second verification information according to the recorded RSSIs and transmit the second authentication to the vehicle.

In some embodiments of the present application, the first verification information may include the RSSIs recorded by the vehicle. Similarly, the second authentication may include the RSSIs recorded by the user's device.

In some embodiments of the present application, each of the RSSIs may correspond to a RSSI level. For example, table 1 shows the correspondence between the RSSI and the RSSI level.

TABLE 1

| RSSI | RSSI level |
|---|---|
| −10~0 decibel-milliwatts (dBm) | 0 |
| −20~−11 dBm | 1 |
| −40~−21 dBm | 2 |
| −80~−41 dBm | 3 |
| <−81 dBm | 4 |

According to Table 1, if a RSSI detected by the vehicle according to a response packet is −70 dBm, the vehicle may determine that the RSSI level of the RSSI is 3. The vehicle may determine RSSI levels of the recorded RSSIs according the correspondence between the RSSI and the RSSI level. The first verification information may include the RSSI levels of the recorded RSSIs. Similarly, the user's device may determine RSSI levels of the recorded RSSIs. The second verification information may include the RSSI levels of the recorded RSSIs.

In some embodiments, the vehicle may remove some noise component of the recorded RSSIs to make the signal smooth. For example, the vehicle may use a low pass filter or a Svizsky-Golay filter to filter the recorded RSSIs. It is assumed that the vehicle recorded N RSSIs. After filtering the N RSSIs, M RSSIs remain. Then the vehicle may sort the M RSSIs from lowest to highest, and determine the RSSI levels of the M RSSIs. In some embodiments, the RSSI level may be use a Gray code. Then, the vehicle may rearrange the RSSI levels using Gray code back to their original place as per index number, and encode the RSSI levels using Gray code to obtain the first verification information. The user's device may perform the similar procedures to obtain the second verification information.
Step 309, The vehicle verifies an identity of the user's device according to the first verification information and the second verification information.

The vehicle may determine similarity of the first verification information and the second verification information. If the similarity of the first verification information and the second verification information is more than a preset threshold (e.g., 75%), the vehicle may determine that the user's device passes identity authentication and transmit a successful authentication indication to the user's device. The successful authentication indication is sued to indicate that the user's device passes the identity authentication. In some embodiments, after passing the identity authentication, the user's device and the vehicle may determine a distance and a range according to time of flight (TOF) and/or angle of arrival (AOA) and determine whether to unlock the vehicle according to the result of the determination. In some another embodiments, the RSSI may be used to verify close proximity together with the range estimated by the TOF and the AOA. Therefore, the user's device and the vehicle may determine whether to unlock the vehicle according to the RSSI, the TOF and the AOA.

If the similarity of the first verification information and the second verification information is equal to or less than the preset threshold (e.g., 75%), the vehicle may determine that the user's device does not passes the identity authentication. The vehicle may send a failure indication which is used to indicate that the user's device does not pass the identity authentication to the user's device, or the vehicle may ignore subsequent messages sent by the user's device.

Due to reciprocity property of the wireless channel, the sets of BLE features e.g., RSS on the vehicle and the user's device shows high correlation in their variation trends, however, the individual values may not be exactly same because of noise in channel, hardware factors, etc. Only the pair of connected wireless devices can have similar RSS values due to reciprocity property of wireless channel. Adversaries or other BLE devices in the vicinity of legitimate devices cannot predict the RSS values obtained by legitimate parties. RSS information can be used to confirm different user activities. Both the parties i.e., the vehicle and the user's device can confirm this behavior. If another device e.g., adversary (eavesdropper) is present in the same vicinity, and is able to overhear all the communication in the (same) channel used by legitimate devices. The RSS observed by this device (by received packets/signal) will be un-correlated with respect to the legitimate devices due to multi-path effects of wireless channel. Therefore, the present application provides an identity authentication solution for securing ranging and proximity estimation for KES.

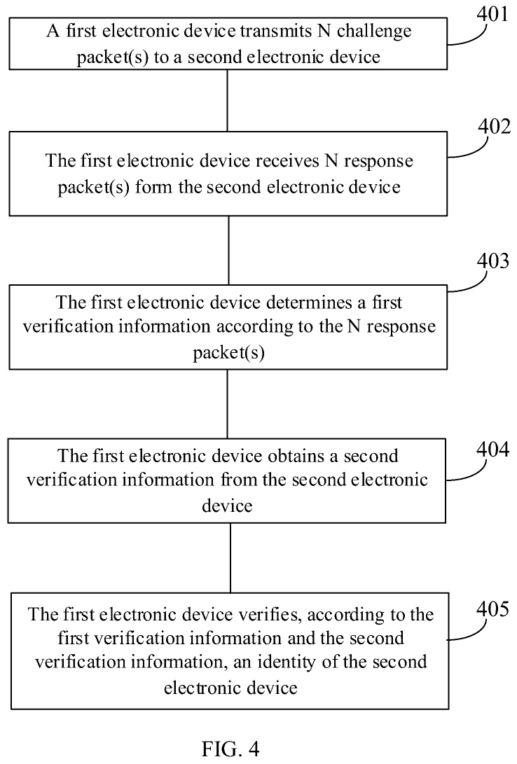

FIG. 4 shows a flowchart of the embodiment of a method for verifying an identity of an electronic device.
Step 401: A first electronic device transmits N challenge packet(s) to a second electronic device. N is a positive integer greater than or equal to 1.

The first electronic device may be an electronic device which employs one or more antenna array with multiple antennas. The second electronic device may only have a single antennal.

For example, as mentioned in FIG. 3, the first electronic device may be a vehicle and the second electronic device may be a user's device. The user's device may be a smartphone, a smart watch, a key of the vehicle or the like.

For another example, the first electronic device may be a laptop, a computer, a smart door lock or the like. The second electronic device may be a smartphone, a smart watch, a smart band or the like.

For another example, the first electronic device may be an equipment equipped in the above-mentioned device, and the second electronic device may be an equipment equipped in the above-mentioned device. For example, the first electronic device may be a telematics box (TBox). The second electronic device may be a radio module in the smartphone.

Before transmitting the first challenge packet to the second electronic device, the first electronic device and the second electronic device may establish a wireless connection. For example, as mentioned in FIG. 3, the first electronic device and the second electronic device establish the wireless connection by using BLE. The first electronic device and the second electronic device may use other wireless technologies to establish the wireless connection, such as ZIGBEE, the Institute of Electrical and Electronics Engineers (IEEE) 802.15.4, ultra-wideband (UWB) and so on.
Step 402: The first electronic device receives N response packet(s) from the second electronic device. The N response packet(s) being in one-to-one correspondence with the N challenge packet(s).

The N challenge packet(s) may be transmitted by using channel hopping. In each channel, the first electronic device may transmit one or more of the N challenge packet(s) to the second electronic device. Correspondingly, the second electronic device may response the corresponding response packet(s) in the same channel. The parameters for the channel hopping may be preset in both the first electronic device and the second electronic device according to a trusted party, e.g., cloud service, ore may be negotiated during the establishment of wireless communication. The process for negotiating the parameters, transmitting the challenge packet(s) and receiving the response packet(s) is detailed in FIG. 3, which will not be described herein again.
Step 403: The first electronic device determines a first verification information according to the N response packet(s). The first verification information is used to indicate RSS information of the N response packet(s).
Step 404: The first electronic device obtains a second verification information from the second electronic device. The second verification information is used to indicate RSS information of the N challenge packet(s).
Step 405: The first electronic device verifies, according to the first verification information and the second verification information, an identity of the second electronic device.

According to the technical solution in FIG. 4, the first electronic device may use the RSS information to verify the identity of the second electronic device. The RSS information on the first electronic device and the second electronic device shows high correlation in their variation trends. It is difficult for a third party device to predict or obtain the RSS information. Therefore, the technical solution in FIG. 4 provides an efficiently identity authentication procedure by using the property of the RSS.

In some embodiment of the present application, the first electronic device may determine a nonce and transmit the nonce to the second electronic device, determine the N challenge packet(s). Each of the N challenge packet(s) includes a first encryption information encrypted by a preset key, wherein the first encryption information includes the nonce. Corresponding, the second device may receive the nonce from the first electronic device.

The nonce may be used to assist in verifying the identity of both parties in communication. For example, if the nonce obtained by the second electronic device decrypting the first encrypted information is not previously sent by the first electronic device, the second electronic device can determine that the first electronic device may be an illegal device and do not response a response packet to the device. If the nonce obtained by the second electronic device decrypting the first encrypted information is previously sent by the first electronic device, the second electronic may determine a corresponding response packet and send the response packet to the first electronic device. The key which is used to encrypt/decrypt the first encryption information may be a pre-shared key, or may be determined according to the ID of the second electronic device.

In some embodiment of the present application, each of the N challenge packet(s) includes a first check information. After decrypting the first encryption information, the second electronic device may use the first check information to verify data integrity of the decrypted information (that is the nonce). If the data integrity of the decrypted information pass the verification, the second electronic may determine the corresponding response packet and transmit the response packet to the first device. If the data integrity of the decrypted information does not pass the verification, the second electronic may indicate the first electronic device retransmit the challenge packet. The first check information may be MAC or HMAC of the decrypted information. The key which is used to determine the first check information may be the same as the key which is used to encrypt/decrypt the first encryption information.

Similarly, each of the N response packet(s) includes a second check information which being used to verify data integrity of the second encryption information in each of the N response packet(s). After decrypting the second encryption information, the first electronic device may use the second check information to verify data integrity of the decrypted information (that is the nonce). If the data integrity of the decrypted information pass the verification, the first electronic may determine the corresponding response packet and transmit the next challenge packet to the second device. If the data integrity of the decrypted information does not pass the verification, the first electronic may indicate the second electronic device retransmit the response packet. The second check information may be MAC or HMAC of the decrypted information. The key which is used to determine the second check information may be the same as the key which is used to encrypt/decrypt the second encryption information.

In some embodiment of the present application, the first electronic device determines a first verification information according to the N response packet(s) includes determines K piece(s) of RSS information according to the N response packet(s), wherein each of the K piece(s) of the RSS information is in correspondence with one of the N response packet(s), K is a positive integer greater than or equal to N, determines the first verification information according to the K piece(s) of the RSS information.

In some embodiment of the present application, the first electronic device may determine that the N response packet(s) are trusted according to the nonce in each of the N response packet(s) before determining the K piece(s) of RSS information according to the N response packet(s).

For example, each of the N response packet(s) may include a second encryption information and a second check information. Similarly, the second encryption information may include the nonce. The key used to encrypt/decrypt the second encryption information may be the same as the key used to encrypt/decrypt the first encryption information. The first electronic device may use the key to decrypt the second information to obtain decrypted information (that is the nonce). The first electronic device may compare the nonce in the decrypted information with the previously transmitted nonce. If the nonce in the decrypted information and the previously transmitted nonce are the same, the first electronic device may use the second check information to verify data integrity of the encrypted information. If the encrypted information passes the verification, the first electronic device may determine that the response packet is a trusted packet, if the encrypted information does not pass the verification, the first electronic device may indicate the second electronic device to retransmit the response packet. If the nonce in the decrypted information and the previously received nonce are different, the first electronic device may determine that the response packet is not a trusted packet.

The RSS information may be the RSS of the corresponding response packet or the RSSI of the corresponding response packet.

In some embodiment, the first electronic device may apply a filter to the K piece(s) of the RSS information to obtain M piece(s) of the RSS information, wherein M is a positive integer less than or equal to N, determine the first verification information according to the M piece(s) of the RSS information.

In some embodiment, the first electronic device may determine M piece(s) of RSS level information according to M piece(s) of RSS information, wherein the M piece(s) of the RSS level information are in one-to-one correspondence with the M piece(s) of the RSS information, determine the first verification information according to the M piece(s) of the RSS level information. According to the above-mentioned solution, the first electronic uses the RSS level to replace the RSS information. Therefore, data that the first device sends to the second device will be reduced.

In some embodiments, the RSS level may be use the Gray code. Gray code is an ordering of the binary numeral system such that two successive values differ in only one bit (binary digit). The Gray code may avoid an error or ambiguity during the transition from one number to the next.

The process for determining the first authentication information is detailed in FIG. 3, which will not be described herein again.

In some embodiment of the present application, the second electronic device determines a second verification information according to the N challenge packet(s) includes determines K piece(s) of RSS information according to the N challenge packet(s), wherein each of the K piece(s) of the RSS information is in correspondence with one of the N challenge packet(s), K is a positive integer greater than or equal to N, determines the second verification information according to the K piece(s) of the RSS information.

In some embodiment of the present application, the second electronic device may determine that the N challenge packet(s) are trusted according to the nonce in each of the N challenge packet(s) before determining the K piece(s) of RSS information according to the N challenge packet(s).

For example, each of the N challenge packet(s) may include a first encryption information and a first check information. Similarly, the first encryption information may include the nonce. The key used to encrypt/decrypt the first encryption information may be the same as the key used to encrypt/decrypt the first encryption information. The second electronic device may use the key to decrypt the second information to obtain decrypted information (that is the nonce). The second electronic device may compare the nonce in the decrypted information with the previously received nonce. If the nonce in the decrypted information and the previously received nonce are the same, the second electronic device may use the first check information to verify data integrity of the encrypted information. If the encrypted information passes the verification, the second electronic device may determine that the challenge packet is a trusted packet, if the encrypted information does not pass the verification, the second electronic device may indicate the first electronic device to retransmit the challenge packet. If the nonce in the decrypted information and the previously received nonce are different, the second electronic device may determine that the challenge packet is not a trusted packet.

The RSS information may be the RSS of the corresponding challenge packet or the RSSI of the corresponding challenge packet.

In some embodiment, the second electronic device may apply a filter to the K piece(s) of the RSS information to obtain M piece(s) of the RSS information, wherein M is a positive integer less than or equal to N, determine the second verification information according to the M piece(s) of the RSS information.

In some embodiment, the second electronic device may determine M piece(s) of RSS level information according to M piece(s) of RSS information, wherein the M piece(s) of the RSS level information are in one-to-one correspondence with the M piece(s) of the RSS information, determine the second verification information according to the M piece(s) of the RSS level information. According to the above-mentioned solution, the second electronic uses the RSS level to replace the RSS information. Therefore, data that the second device sends to the first device will be reduced.

The process for determining the second authentication information is detailed in FIG. 3, which will not be described herein again.

In some embodiments, the first electronic device may determine similarity of the first verification information and the second verification information. If the similarity of the first verification information and the second verification information is more than a threshold, the first electronic device may transmit a successful authentication indication to the second electronic device. The successful authentication indication is used to indicate that the second electronic device passed identity authentication. Then, the second electronic may determine a distance and a range according to TOF and AOA. Or, in some embodiments, the second electronic device may determine the distance and the range according to the TOF, the AOA and the RSSI.

Further, in some embodiments, multiple antennas may be used to help to get sufficient randomness in RSS values captured on both devices (e.g. spatial diversity for de-correlating the successive RSS samples). Hence this solution works very well for completely static devices also (Not dependent on device mobility). Hence this solution is more robust and faster compared to other RSS solutions depending on mobility.

Further the latest BLE standard version 5.1 and above support angle of arrival and time of flight estimation using BLE channel features. Hence the technical solution can be easily implemented on all platforms that support this feature and antenna array.

The technical solution in the above-mentioned embodiments can also be implemented to other wireless communication methods used for direction finding and ranging for e.g., UWB, short range wireless technologies (ZIGBEE/IEEE 802.15.4) etc.

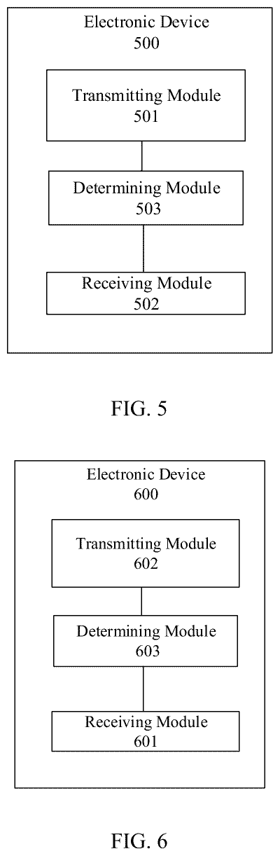

FIG. 5 is a schematic block diagram of an electronic device 500 according to an embodiment of this disclosure. As shown in FIG. 5, the electronic device 500 includes a transmitting module 501, a receiving module 502, and a determining module 503.

The transmitting module 501 is configured to transmit N challenge packet(s) to another electronic device, wherein N being a positive integer greater than 1.

The receiving module 502 is configured to receive N response packet(s) from the other electronic device, wherein the N response packet(s) being in one-to-one correspondence with the N challenge packet(s).

The determining module 503 is configured to determine a first verification information, according to the N response packet(s), wherein the first verification information being used to indicate RSS information of the N response packet(s).

The determining module 503 is further configured to obtain a second verification information from the second electronic device, wherein the second verification information being used to indicate information RSS of the N challenge packet(s).

The determining module 503 is further configured to verify, according to the first verification information and the second verification information, an identity of the other electronic device.

Optionally, the electronic device 500 may be the first electronic device or a component of the first electronic device mentioned in the above-mentioned embodiments. The other electronic device maybe the second electronic device or a component of the second electronic device mentioned in the above-mentioned embodiments.

Optionally, in some embodiments, the determining module 503 is further configured to determine a nonce, the transmitting module, further configured to transmit the nonce to the other electronic device. The determining module 503 is further configured to determine the N challenge packet(s), wherein each of the N challenge packet(s) includes a first encryption information encrypted by a preset key, wherein the first encryption information includes the nonce.

Optionally, in some embodiments, each of the N challenge packet(s) includes a first check information which being used to verify data integrity of the first encryption information in each of the N challenge packet(s).

Optionally, in some embodiments, the determining module 503 is further configured to determine K piece(s) of RSS information according to the N response packet(s), wherein each of the K piece(s) of the RSS the information is in correspondence with one of the N response packet(s),

K is a positive integer greater than or equal to N, determine the first verification information according to the K piece(s) of the RSS information.

Optionally, in some embodiments, the determining module 503 is further configured to apply a filter to the K piece(s) of the RSS information to obtain M piece(s) of the RSS information, wherein M being a positive integer less than or equal to N, determine the first verification information according to the M piece(s) of the RSS information.

In some embodiment, the determining module 503 is further configured to determine M piece(s) of RSS level information according to the M piece(s) of the RSS information, wherein the M piece(s) of the RSS level information being in one-to-one correspondence with the M piece(s) of the RSS information, determine the first verification information according to the M piece(s) of the RSS level information.

Optionally, in some embodiments, the determining module 503 is further configured to determine similarity of the first verification information and the second verification information, the transmitting module, further configured to transmitting a successful authentication indication to the second electronic device if the similarity of the first verification information and the second verification information is more than a threshold, wherein the successful authentication indication being used to indicate that the second electronic device passed identity authentication.

FIG. 6 is a schematic block diagram of an electronic device 600 according to an embodiment of this disclosure. As shown in FIG. 6, the electronic device 600 includes a receiving module 601, a transmitting module 602, and a determining module 603.

The receiving module 601 is configured to receive N challenge packet(s) from another electronic device, wherein N being a positive integer greater than 1.

The transmitting module 602 is configured to transmit N response packet(s) to the other electronic device, wherein the N response packet(s) being in one-to-one correspondence with the N challenge packet(s).

The determining module 603 is configured to determine by the second electronic device, a second verification information according to the N challenge packet(s).

The transmitting module 602 is further configured to transmit the second verification information to the other electronic device.

Optionally, the electronic device 600 may be the second electronic device or a component of the second electronic device mentioned in the above-mentioned embodiments. The other electronic device maybe the first electronic device or a component of the first electronic device mentioned in the above-mentioned embodiments.

Optionally, in some embodiments, the receiving module 601 further configured to receive a nonce, from the other electronic device. The determining module 603 is further configured to determine the N response packet(s), wherein each of the N response packet(s) includes a second encryption information encrypted by a preset key, wherein the second encryption information includes the nonce.

Optionally, in some embodiments, each of the N response packet(s) includes a second check information which being used to verify data integrity of the second encryption information in each of the N response packet(s).

Optionally, in some embodiments, the determining module 603 is further configured to determine K piece(s) of RSS information according to the N challenge packet(s), wherein each of the K piece(s) of the RSS information is in correspondence with one of the N response packet(s), K is a positive integer greater than or equal to N, determine the second verification information according to the K piece(s) of the RSS information.

Optionally, in some embodiments, the determining module 603 is further configured to apply a filter to the K piece(s) of the RSS information to obtain M piece(s) of the RSS information, wherein M being a positive integer less than or equal to N, determine the second verification information according to the M piece(s) of the RSS information.

Optionally, in some embodiments, the determining module 603 is further configured to determine M piece(s) of RSS level information according to the M piece(s) of the RSS information, wherein the M piece(s) of the RSS level information being in one-to-one correspondence with the

M piece(s) of the RSS information, determine the second verification information according to the M piece(s) of the RSS level information.

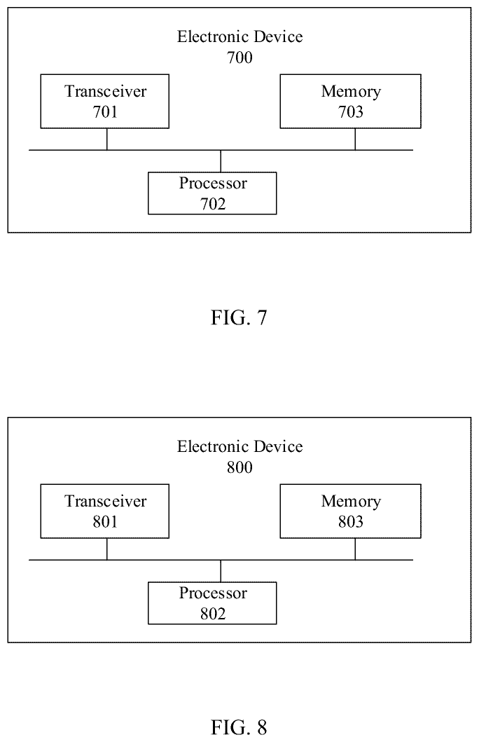

As shown in FIG. 7, an electronic device 700 may include a transceiver 701, a processor 702, and a memory 703. The memory 703 may be configured to store code, instructions, and the like executed by the processor 702. The electronic device 700 may be the first electronic device or a component of the first electronic device in the above-mentioned embodiments.

It should be understood that the processor 702 may be an integrated circuit chip and has a signal processing capability. In an implementation process, steps of the foregoing method embodiments may be completed by using a hardware integrated logic circuit in the processor, or by using instructions in a form of software. The processor may be a general purpose processor, a digital signal processor (DSP), an application-specific integrated circuit (ASIC), a field-programmable gate array (FPGA) or another programmable logic device, a discrete gate or transistor logic device, or a discrete hardware component. The processor may implement or perform the methods, the steps, and the logical block diagrams that are disclosed in the embodiments of the present disclosure. The general purpose processor may be a microprocessor, or the processor may be another processor or the like. The steps of the methods disclosed with reference to the embodiments of the present disclosure may be directly performed and completed by a hardware decoding processor, or may be performed and completed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps of the foregoing methods in combination with hardware in the processor.

It may be understood that the memory 703 in the embodiments of the present disclosure may be a volatile memory or a nonvolatile memory, or may include both a volatile memory and a nonvolatile memory. The nonvolatile memory may be a read-only memory (ROM), a programmable ROM (PROM), an erasable PROM (EPROM), an electrically EPROM (EEPROM), or a flash memory. The volatile memory may be a random-access memory (RAM) and is used as an external cache. By way of example rather than limitation, many forms of RAMs may be used, and are, for example, a static RAM (SRAM), a dynamic RAM (DRAM), a synchronous DRAM (SDRAM), a double data rate (DDR) SDRAM (SDRAM), an enhanced SDRAM (ESDRAM), a synchronous link DRAM (SLDRAM), and a direct Rambus (DR) RAM.

As shown in FIG. 8, an electronic device 800 may include a transceiver 801, a processor 802, and a memory 803. The memory 803 may be configured to store code, instructions, and the like executed by the processor 802. The electronic device 800 may be the second electronic device or a component of the second electronic device in the above-mentioned embodiments.

It should be understood that the processor 802 may be an integrated circuit chip and has a signal processing capability. In an implementation process, steps of the foregoing method embodiments may be completed by using a hardware integrated logic circuit in the processor, or by using instructions in a form of software. The processor may be a general purpose processor, a DSP, an ASIC, an FPGA or another programmable logic device, a discrete gate or transistor logic device, or a discrete hardware component. The processor may implement or perform the methods, the steps, and the logical block diagrams that are disclosed in the embodiments of the present disclosure. The general purpose processor may be a microprocessor, or the processor may be another processor or the like. The steps of the methods disclosed with reference to the embodiments of the present disclosure may be directly performed and completed by a hardware decoding processor, or may be performed and completed by using a combination of hardware in the decoding processor and a software module. The software module may be located in a mature storage medium in the art, such as a RAM, a flash memory, a ROM, a PROM, an EEPROM, or a register. The storage medium is located in the memory, and the processor reads information in the memory and completes the steps of the foregoing methods in combination with hardware in the processor.

It may be understood that the memory 803 in the embodiments of the present disclosure may be a volatile memory or a nonvolatile memory, or may include both a volatile memory and a nonvolatile memory. The nonvolatile memory may be a ROM, a PROM, an EPROM, an EEPROM, or a flash memory. The volatile memory may be a RAM and is used as an external cache. By way of example rather than limitation, many forms of RAMs may be used, and are, for example, a SRAM, a DRAM, an SDRAM, a DDR SDRAM, an ESDRAM, an SLDRAM, and a DR RAM.

It should be noted that the memory in the systems and the methods described in this specification includes but is not limited to these memories and a memory of any other appropriate type.

An embodiment of this disclosure further provides a system chip, where the system chip includes an input/output interface, at least one processor, at least one memory, and a bus. The at least one memory is configured to store instructions, and the at least one processor is configured to invoke the instructions of the at least one memory to perform operations performed by the first electronic device in the methods in the foregoing embodiments.

An embodiment of this disclosure further provides a system chip, where the system chip includes an input/output interface, at least one processor, at least one memory, and a bus. The at least one memory is configured to store instructions, and the at least one processor is configured to invoke the instructions of the at least one memory to perform operations performed by the second electronic device in the methods in the foregoing embodiments.

An embodiment of this disclosure further provides a computer storage medium, where the computer storage medium may store a program instruction for performing the steps performed by the first electronic device in the foregoing methods.

Optionally, the storage medium may be the memory 703.

An embodiment of this disclosure further provides a computer storage medium, where the computer storage medium may store a program instruction for performing the steps performed by the second electronic device in the foregoing methods.

Optionally, the storage medium may be the memory 803.

An embodiment of this disclosure further provides a computer program product is provided, wherein when the computer program product runs on an electronic device, the electronic device is enabled to perform the steps performed by the first electronic device in the foregoing methods.

According to a twelfth aspect, a computer program product is provided, wherein when the computer program product runs on an electronic device, the electronic device is enabled to perform the steps performed by the second electronic device in the foregoing methods.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiment. Details are not described herein again.

In the several embodiments provided in this disclosure, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions in this disclosure essentially, or the part contributing to other examples, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this disclosure. The foregoing storage medium includes any medium that can store program code, such as a Universal Serial Bus (USB) flash drive, a removable hard disk, a ROM, a RAM, a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method implemented by a first electronic device and comprising:
transmitting N challenge packets to a second electronic device, wherein N is a first positive integer greater than or equal to 1;
receiving N response packets from the second electronic device, wherein the N response packets are in one-to-one correspondence with the N challenge packets;
determining first verification information according to the N response packets, wherein the first verification information indicates first received signal strength (RSS) information of the N response packets;
obtaining second verification information from the second electronic device, wherein the second verification information indicates second RSS information of the N challenge packets; and
verifying an identity of the second electronic device according to the first verification information and the second verification information.

2. The method of claim 1, wherein before transmitting the N challenge packets, the method further comprises:
determining a nonce;
transmitting the nonce to the second electronic device; and
determining the N challenge packets, wherein each of the N challenge packets comprises: first encryption information encrypted using a preset key, and wherein the first encryption information comprises the nonce, a packet index, and a first command identification (ID).

3. The method of claim 2, wherein each of the N challenge packets further comprises first check information for verifying data integrity of the first encryption information in each of the N challenge packets.

4. The method of claim 1, wherein determining the first verification information comprises:
determining K pieces of third RSS information according to the N response packets, wherein each of the K pieces is in correspondence with one of the N response packets, wherein K is a second positive integer greater than or equal to N; and
determining the first verification information according to the K pieces.

5. The method of claim 4, wherein determining the first verification information comprises:
applying a filter to the K pieces to obtain M pieces of the third RSS information, wherein M is a third positive integer less than or equal to K; and
determining the first verification information according to the M pieces.

6. The method of claim 1, further comprising:
determining a similarity between the first verification information and the second verification information; and
transmitting a successful authentication indication to the second electronic device when the similarity is more than a threshold, wherein the successful authentication indication indicates that the second electronic device passed identity authentication.

7. A first electronic device comprising:
one or more memories configured to store instructions; and
one or more processors coupled to the one or more memories and configured to execute the instructions to cause the first electronic device to:
transmit N challenge packets to a second electronic device, wherein N is a first positive integer greater than or equal to 1;
receive N response packets from the second electronic device, wherein the N response packets are in one-to-one correspondence with the N challenge packets;
determine a first verification information according to the N response packets, wherein the first verification information indicates first received signal strength (RSS) information of the N response packets;
obtain a second verification information from the second electronic device, wherein the second verification information indicates second RSS information of the N challenge packets; and
verify an identity of the second electronic device according to the first verification information and the second verification information.

8. The first electronic device of claim 7, wherein the one or more processors are further configured to execute the instructions to cause the first electronic device to:
determine a nonce;
transmit the nonce to the second electronic device; and
determine the N challenge packets, wherein each of the N challenge packets comprises first encryption information encrypted using a preset key, and wherein the first encryption information comprises the nonce.

9. The first electronic device of claim 8, wherein each of the N challenge packets further comprises first check information for verifying data integrity of the first encryption information in each of the N challenge packets.

10. The first electronic device of claim 7, wherein the one or more processors are further configured to execute the instructions to cause the first electronic device to:
determine K pieces of third RSS information according to the N response packets, wherein each of the K pieces is in correspondence with one of the N response packets, wherein K is a second positive integer greater than or equal to N; and
determine the first verification information according to the K pieces.

11. The first electronic device of claim 10, wherein the one or more processors are further configured to execute the instructions to cause the first electronic device to:
apply a filter to the K pieces to obtain M pieces of the third RSS information, wherein M is a third positive integer less than or equal to K; and
determine the first verification information according to the M pieces.

12. The first electronic device of claim 7, wherein the one or more processors are further configured to execute the instructions to cause the first electronic device to:
determine a similarity between the first verification information and the second verification information; and
transmit a successful authentication indication to the second electronic device when the similarity is more than a threshold, wherein the successful authentication indication indicates that the second electronic device passed identity authentication.

13. A second electronic device comprising:
one or more memories configured to store instructions; and
one or more processors coupled to the one or more memories and configured to execute the instructions to cause the second electronic device to:
receive N challenge packets from a first electronic device, wherein N is a first positive integer greater than or equal to 1;
transmit N response packets to the first electronic device, wherein the N response packets are in one-to-one correspondence with the N challenge packets;
determine verification information according to the N challenge packets, wherein the verification information indicates first received signal strength (RSS) information of the N challenge packets; and
transmit the verification information to the first electronic device.

14. The second electronic device of claim 13, wherein the one or more processors are further configured to execute the instructions to cause the second electronic device to:
receive a nonce from the first electronic device; and
determine the N response packets, wherein each of the N response packets comprises encryption information encrypted using a preset key, and wherein the encryption information comprises the nonce.

15. The second electronic device of claim 14, wherein each of the N response packets comprises second check information for verifying data integrity of the encryption information in each of the N response packets.

16. The second electronic device of claim 13, wherein the one or more processors are further configured to execute the instructions to cause the second electronic device to:
determine K pieces of second RSS information according to the N challenge packets, wherein each of the K pieces is in correspondence with one of the N response packets, wherein K is a second positive integer greater than or equal to N; and
determine the verification information according to the K pieces.

17. The second electronic device of claim 16, wherein the one or more processors are further configured to execute the instructions to cause the second electronic device to:
apply a filter to the K pieces to obtain M pieces of the second RSS information, wherein M is a third positive integer less than or equal to K; and
determine the verification information according to the M pieces.

18. The second electronic device of claim 17, wherein the filter is a low-pass filter or a Svizsky-Golay filter.

19. The second electronic device of claim 16, wherein the one or more processors are further configured to execute the instructions to cause the second electronic device to:
receive an encrypted nonce from the first electronic device; and
decrypt the encrypted nonce using a preset key to obtain the nonce.

20. The second electronic device of claim 16, wherein before determining the K pieces, the one or more processors are further configured to execute the instructions to cause the second electronic device to determine, according to a nonce in each of the N challenge packets, whether the N challenge packets are trusted.
